(19) United States
(12) Patent Application Publication
(10) Pub. No.: US 2009/0231468 A1
(43) Pub. Date: Sep. 17, 2009

(54) Digital imaging apparatus enabled to control flash light intensity, method of controlling the digital imaging apparatus, and recording medium having recorded thereon program for executing the method

(75) Inventor: Tomonaga Yasuda, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/380,705

(22) Filed: Mar. 3, 2009

(30) Foreign Application Priority Data
Mar. 13, 2008 (KR) 10-2008-0023428

(51) Int. Cl. H04N 9/68; H04N 5/235; H04N 5/232; H04N 5/228; H04N 5/222

(52) U.S. Cl. 348/234; 348/362; 348/345; 348/222.1; 348/371; 348/333.01; 348/E05.034; 348/E05.031; 348/E05.022

(57) ABSTRACT

Provided is a method of controlling a digital imaging apparatus enabled to maintain a ready-to-capture state, with a shutter opened, the method comprising (a) displaying an image of a target subject in a live-view, with the shutter opened; (b) obtaining live-view information of the image; (c) when an imaging start signal is input, before a main exposure, metering a reflected light from the target subject by using a lighter sensor; (d) obtaining metering information; (e) determining a condition for the main exposure by using the live-view information and the metering information; and (f) performing an imaging operation while performing the main exposure by using the determined condition for the main exposure.

### CROSS-REFERENCE TO RELATED PATENT APPLICATION

This application claims the benefit of Korean Patent Application No. 10-2008-0023428, filed on Mar. 13, 2008, in the Korean Intellectual Property Office, the disclosure of which is incorporated herein in its entirety by reference.

### BACKGROUND

1. Field of the Invention

The present invention relates to a digital imaging apparatus, and more particularly, to a digital imaging apparatus enabled to adjust flash light intensity by using information obtained in a live-view mode and to perform an imaging operation, a method of controlling the digital imaging apparatus, and a recording medium having recorded thereon a program for executing the method.

2. Description of the Related Art

Digital cameras, which use an image sensor such as a charge-coupled device (CCD) or a complementary metal-oxide semiconductor (CMOS) converting optical data to an electric signal, instead of using a film, are widely used nowadays.

Such digital cameras include single-lens reflex (SLR) digital cameras and compact digital cameras.

In general, an SLR digital camera can perform an imaging operation under various conditions since the lens can be exchanged. Also, an SLR digital camera uses a high performance image sensor having a wide light-receiving area so that the SLR digital camera can realize a high quality image, compared to a compact digital camera. Because of the aforementioned reasons, SLR digital cameras are being used by an increasing number of users.

Due to its structure, the SLR digital camera has historically had a problem with a live-view function that realizes a moving image for checking framing on its liquid crystal display (LCD) in a ready-to-capture state, compared to the compact digital camera having the live-view function.

However, SLR digital cameras enabled to realize a live-view function by using the image sensor have recently been developed. Such an SLR digital camera controls a status, in which a reflex mirror swings upward and a focal-plane shutter opens in a ready-to-capture state, to be maintained for a long time, thereby realizing the live-view function. Otherwise, an SLR digital camera realizes a live-view function in a state in which a reflex mirror or a mirror box is removed so as to eliminate a release time lag followed by an up/down movement of the reflex mirror, and the focal-plane shutter is opened.

Such an SLR digital camera enabled to realize the live-view function by using the image sensor can perform various functions since the SLR digital camera can perform an automatic exposure (AE) via the image sensor which cannot be performed by an exposure sensor equipped in a conventional SLR digital camera. For example, the SLR digital camera can interpret a received image of a target subject via a live-view, detect a human face, and perform the AE, focusing the detected human face. Also, in the case where a focus is adjusted via the live-view, the SLR digital camera can perform an autofocus (AF) so as to focus a position of a specific target subject and can focus a user desired target subject.

Meanwhile, when an imaging operation is performed under a night condition or an indoor condition which lacks appropriate light intensity for obtaining a proper image, a flash equipped in the SLR digital camera emits a light so as to increase the light intensity and the imaging operation is performed.

However, in the case where the imaging operation with emission of the flash is performed, if a reflection from a main target subject with respect to a pre-flash is strong since the main target subject exists in the vicinity of the SLR digital camera, the image sensor has to meter brightness of the main target subject, meter a main target subject's reflected light against the pre-flash, and control light intensity of a main flash. Thus, there is a problem since the SLR digital camera cannot accurately adjust the light intensity in a dynamic range of the image sensor realizing the live-view.

Although a flash control can be achieved by increasing a metering number of times so as to solve the problem, it takes time to realize the live-view, changing a gain setting of the image sensor, due to an increase of the metering number of times. Therefore, the release time lag is considerably extended, compared to a system using a lighter sensor.

Meanwhile, when an imaging operation with emission of a flash is performed by the conventional SLR digital camera system controlling an exposure by using the lighter sensor, problems related to the flash control or the release time lag do not occur, wherein the problems occur in a system controlling the exposure by using the image sensor. However, the conventional SLR digital camera system cannot use functions which are available via the live-view by using the image sensor and which are available in a conventional compact digital camera. For example, a conventional compact digital camera can recognize a face of a target subject input to the image sensor via the live-view and can control an exposure, putting emphasis on the face. However, when the imaging operation with the emission of the flash is performed, the conventional SLR digital camera system controlling the flash light intensity by using the lighter sensor has a problem in recognizing the face of the target subject input to the image sensor and controlling the exposure, putting emphasis on the face.

### SUMMARY

The present invention provides a digital imaging apparatus enabled to adjust flash light intensity by using information obtained in a live-view mode and to perform an imaging operation, a method of controlling the digital imaging apparatus, and a recording medium having recorded thereon a program for executing the method.

According to an aspect of the present invention, there is provided a method of controlling a digital imaging apparatus enabled to maintain a ready-to-capture state, with a shutter of the digital imaging apparatus opened, the method including the operations of: (a) displaying an image of a target subject in a live-view, with the shutter opened; (b) obtaining live-view information of the image; (c) when an imaging start signal is input, before a main exposure, metering a reflected light from the target subject by using a lighter sensor; (d) obtaining metering information; (e) determining a condition for the main exposure by using the live-view information and the metering information; and (f) performing an imaging operation while performing the main exposure by using the determined condition for the main exposure.

In the operation of (a), a display screen of the target subject displayed in the live-view may be divided into a plurality of areas, and in the operation of (c), the lighter sensor is enabled to perform metering for each of a plurality of divided areas of the lighter sensor and which respectively correspond to the plurality of divided areas of the display screen.

The live-view information may include position information about a main target subject in the display screen via the live-view.

The position information about the main target subject in the display screen via the live-view may include a focus position obtained when an autofocus (AF) is performed.

The live-view information may further include information about a part of a human that is the main target subject in the display screen via the live-view.

The information about the part of the human may include face information of the human.

The face information of the human may include at least one of the number of faces, positions of the faces, and sizes of the faces which exist in the display screen via the live-view.

The live-view information may include brightness information about the main target subject in the display screen via the live-view, when an automatic exposure (AE) is performed.

The operation of (c) may include the operation of metering a reflected light in a normal state without a pre-flash and metering a reflected light with the pre-flash.

The live-view information obtained in the operation of (a) may affect the metering information obtained in the operation of (c).

The main exposure in the operation of (f) may be performed with emission of a flash.

The main exposure in the operation of (f) may be performed without the emission of the flash.

In the operation of (a), the display screen of the target subject displayed in the live-view may be divided into the plurality of areas, and in the operation of (c), the lighter sensor is enabled to perform metering for each of a plurality of divided areas of the lighter sensor which respectively correspond to the plurality of divided areas of the display screen, and wherein the live-view information comprises information about a face that is the main target subject in the display screen via the live-view, focus position information about the face when an AF is performed, and brightness information about the face when an AE is performed.

According to another aspect of the present invention, there is provided a computer readable recording medium having recorded thereon a program for executing the method.

According to another aspect of the present invention, there is provided a digital imaging apparatus having a shutter control device for maintaining a shutter-opened-state and a lighter sensor for metering a light having passed through a lens, the digital imaging apparatus including: a live-view information obtainment unit storing and maintaining information obtained when an image of a target subject is displayed in a live-view, with a shutter of the digital imaging apparatus opened; a metering information obtainment unit metering a reflected light from the target subject by using the lighter sensor; and an exposure adjustment unit adjusting an exposure condition for a main exposure by using information obtained by the live-view information obtainment unit and the metering information obtainment unit.

The exposure adjustment unit may include an area match unit matching a live-view display screen enabled to be divided into a plurality of areas with a plurality of divided areas of the lighter sensor; and an exposure value calculation unit calculating the exposure condition for the main exposure by using metering information for each of the divided areas of the lighter sensor and which is obtained by using the live-view information obtainment unit and the area match unit.

The live-view information obtainment unit may obtain position information about a main target subject in the live-view display screen.

The position information about the main target subject obtained by the live-view information obtainment unit may include a focus position obtained when an AF is performed for the main target subject in the live-view display screen.

The live-view information obtainment unit may further obtain information about a part of a human that is the main target subject in the live-view display screen.

The digital imaging apparatus may further include a face information detection unit, wherein the information about the part of the human includes face information which is of the human and which is detected by the face information detection unit.

The face information detection unit may include at least one of the number of faces, positions of the faces, and sizes of the faces which exist in the live-view display screen.

The live-view information obtainment unit may include brightness information about the main target subject in the live-view display screen, when an AE is performed.

The shutter may be a focal plane shutter.

The digital imaging apparatus may be a lens-exchangeable type.

The digital imaging apparatus may be a single-lens reflex (SLR) digital camera.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional side view for illustrating a structure of a digital imaging apparatus according to an embodiment of the present invention;

FIG. 2 is a block diagram of the digital imaging apparatus illustrated in FIG. 1 according to an embodiment of the present invention;

FIG. 3 is a block diagram illustrating a schematic structure of a central processing unit (CPU) of the digital imaging apparatus illustrated in FIG. 2, according to an embodiment of the present invention;

FIG. 4 is a block diagram illustrating a schematic structure of a CPU according to another embodiment of the present invention;

FIGS. 5A though 5C are block diagrams illustrating a detailed structure of the CPU of FIG. 3, according to an embodiment of the present invention;

FIGS. 6A through 6C are drawings illustrating a process in which an area match unit matches a divided screen in a live-view with each of a plurality of divided areas of a lighter sensor, according to an embodiment of the present invention;

FIG. 7 is a flowchart of an operation of the digital imaging apparatus of FIG. 1, according to an embodiment of the present invention;

FIG. 8 is a flowchart of an additional operation of the digital imaging apparatus of FIG. 1 with a face detection function, according to another embodiment of the present invention;

FIG. 9 is a detailed flowchart of operation 710 in FIG. 7, according to an embodiment of the present invention;

FIG. 10 is a drawing in which a sensor area of a lighter sensor is divided into a face area and a non-face area by two persons;

FIG. 11 is a group of sensor cells corresponding to the face area; and

FIG. 12 is a group of sensor cells corresponding to the non-face area.

### DETAILED DESCRIPTION OF THE PREFERRED EMBODIMENTS

Various embodiments of the present invention will now be described more fully with reference to the accompanying drawings, in which exemplary embodiments of the invention are shown.

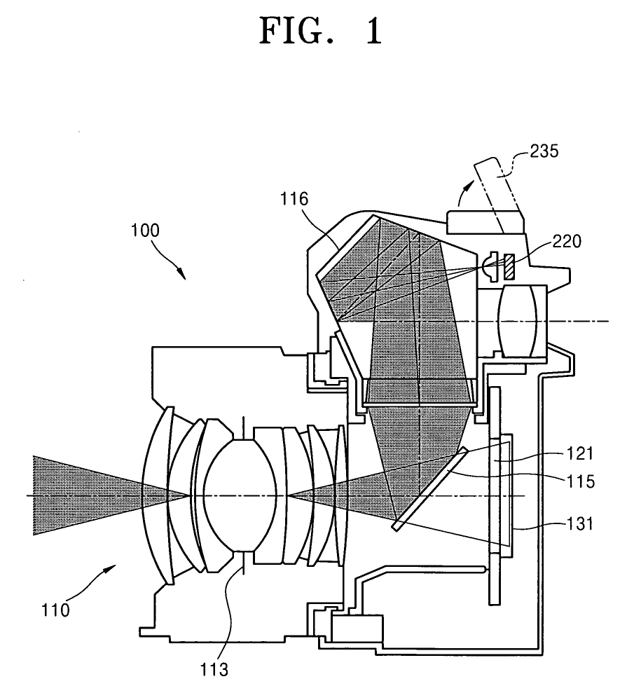

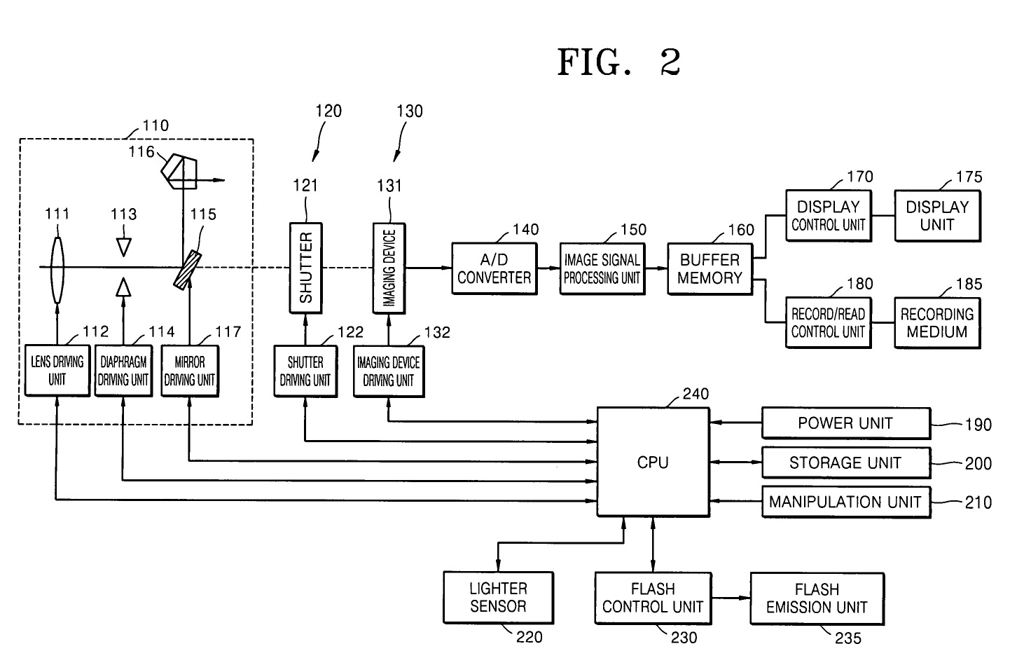

FIG. 1 is a cross-sectional side view for illustrating a structure of a digital imaging apparatus 100 according to an embodiment of the present invention. FIG. 2 is a block diagram of the digital imaging apparatus 100 according to the current embodiment of the present invention.

The digital imaging apparatus 100 of FIGS. 1 and 2 is a single-lens reflex (SLR) digital camera and is enabled so that a lens unit can be detachable therefrom. The digital imaging apparatus according to the present invention is not limited to the structure of the digital imaging apparatus 100 illustrated in FIGS. 1 and 2. In this regard, the digital imaging apparatus 100 of FIGS. 1 and 2 is a single-lens reflex (SLR) digital camera for convenience of description.

Referring to FIGS. 1 and 2, in the digital imaging apparatus 100 according to the current embodiment, a light reflected from a target subject is incident on an imaging unit 130 via an image sensing unit 110 and a shutter unit 120.

The image sensing unit 110 comprises a lens 111, a lens driving unit 112, a diaphragm 113, a diaphragm driving unit 114, a reflex mirror 115, a pentaprism 116, and a mirror driving unit 117.

In the digital imaging apparatus 100 according to the current embodiment, when the reflex mirror 115 swings downward, a light passing through the lens 111 is reflected by the reflex mirror 115 and is transmitted to an imaging unit 130 via the pentaprism 116.

Meanwhile, when the reflex mirror 115 of the SLR digital camera swings upward and a shutter 121 of the shutter unit 120 opens, the light passing through the lens 111 is incident on an imaging device 131 and forms a two-dimensional image corresponding to a three-dimensional image of the target subject.

Although the lens 111 is not elaborately illustrated in FIGS. 1 and 2, the lens 111 may include a zoom lens moving forward and backward in an optical axis direction and consecutively changing a focal length, a focus lens focusing a target subject's image formed on the imaging device 131, and a compensation lens.

A position of the lens 111 of the image sensing unit 110 is controlled by the lens driving unit 112. An opening of the diaphragm 113 is controlled by the diaphragm driving unit 114. The reflex mirror 115 is driven by the mirror driving unit 117, upon a receipt of a release signal. The lens driving unit 112, the diaphragm driving unit 114, and the mirror driving unit 117 receive a control signal from a central processing unit (CPU) 240.

The shutter unit 120 includes the shutter 121 and a shutter driving unit 122.

The shutter 121 controls an exposure time of the light on the imaging device 131 when an imaging operation is performed. The shutter 121 in the current embodiment is a focal plane shutter which is disposed to be parallel to a front side of an imaging surface of the imaging device 131 and which is enabled to opened and closed so as to shield light or allow light to be incident on the imaging surface.

Such a shutter 121 is driven by the shutter driving unit 122 and is enabled to maintain an open state under a ready-to-capture state during which a live-view mode starts and until a second shutter release button S2 is pressed, such that light passing through the image sensing unit 110 is incident on the imaging device 131 and an image processed screen of a target subject is displayed in a live-view via a display unit 175.

Incident light passing through the image sensing unit 110 and the shutter unit 120, that is an optical signal, is converted to an electric signal by the imaging unit 130. For example, the imaging unit 130 includes the imaging device 131 such as a charge-coupled device (CCD) or a complementary metal-oxide semiconductor (CMOS) which converts the optical signal to the electric signal, and an imaging device driving unit 132 which drives the imaging device 131.

The imaging unit 130 may further include a timing control unit (not shown) controlling an exposure time of each pixel comprising the imaging device 131, or reading and controlling a charge.

An analog-to-digital (A/D) converter 140 converts an analog electric signal generated by the imaging device 131 into a digital image signal. The converted digital image signal becomes raw data.

An image signal processing unit 150 performs signal processing of digitized raw data of an analog image so that the digitized raw data may be displayed, and eliminates a black level caused by a dark current generated in the CCD and a color filter array (CFA) which are sensitive to temperature variation. Also, the image signal processing unit 150 performs a gamma correction in which information is encoded in accordance with nonlinearity of human perception, a CFA interpolation in which a Bayer pattern, representing an RGRG line and a GBGB line which are gamma corrected data, is interpolated into an RGB line, an edge compensation in which an interpolated RGB signal is converted to a YUV signal, and a Y signal is filtered by a high-pass filter so that an image becomes clear, an image processing operation in which color values of U and V signals are corrected by using a standard calorimetric system, and the like.

Such a generated image signal is temporally stored in a buffer memory 160, and the temporally stored image signal is displayed in the display unit 175 by a control of a display control unit 170.

In the current embodiment, the display unit 175 is formed of a liquid crystal display (LCD). However, the display unit 175 may be formed of an organic light emitting diode (OLED), a field emission display (FED), and the like.

Also, before an imaging start signal is input, while the ready-to-capture state, in which the reflex mirror 115 swings downward and the shutter 121 opens, is maintained, the image processed screen of the target subject is displayed in the display unit 175 in the live-view, wherein the image processed screen is obtained by the light which has passed through the image sensing unit 110 and incident on the imaging device 131. At this time, the live-view display screen displayed in the display unit 175 may be divided into a plurality of areas which will be described later.

Meanwhile, the image signal temporarily stored in the buffer memory 160 may be input to a record/read control unit 180 which may record the image signal to a recording medium 185 such as a smart card, a compact flash (CF) memory, a memory stick, a secure digital memory card, or the like, by a user signal or by an automatic manner. The record/read control unit 180 may read image data from an image file stored in the recording medium 185 and may input the read image data to the display control unit 170 via the buffer memory 160, thereby controlling an image to be displayed in the display unit 175.

A power unit 190 may supply a predetermined power for operating the digital imaging apparatus 100, and may include at least one of an electric cell such as an internal lithium ion battery and an interface connecting to an external power source.

A storage unit 200 may include an electrically erasable programmable read-only memory (EEPROM) in which an algorithm regarding all operations of the digital imaging apparatus 100 is stored, and a flash memory in which setting data required to operate a processor of the digital imaging apparatus 100 is stored.

A manipulation unit 210 includes buttons for enabling a user to operate the digital imaging apparatus 100 or to set various settings related to an imaging operation. The buttons may include a power button, a first shutter release button S1 as a half shutter, the second shutter release button S2 as a full shutter, a function button for selection of an imaging mode or a reproduction mode, and for setting of an effect parameter, and the like. However, the manipulation unit 210 is not limited to the aforementioned buttons and may have various forms such as a touch screen a touch pad, a remote control, and the like.

A lighter sensor 220 in the form of a photoconductive photodetector meters light intensity reflected from the target subject, and calculates an appropriate exposure amount with respect to the target subject. In particular, for the lighter sensor 220 in an embodiment of the present invention, a through the lens (TTL) metering technique, which meters an exposure time by using the light passing through the lens 111 from the target subject, is used.

Such a lighter sensor 220 may be divided into a plurality of areas and may meter each of the plurality of areas. At this time, in the case where the live-view display screen is enabled to be divided into a plurality of areas, the divided areas of the lighter sensor 220 may respectively correspond to the divided areas of the live-view display screen.

The imaging unit 130 controls emission of a flash emission unit 235, and in particular, controls an emission operation related to a simultaneous reset of the imaging device 131, or related to an opening and closing operation of the shutter 121.

The flash emission unit 235 emits light onto the target subject when the imaging operation is performed in night conditions or dark conditions, or emits light for an efficient imaging operation, even in bright conditions.

An emission control for the flash emission unit 235 is performed when the imaging unit 130 receives a signal from the CPU 240 and outputs an emission command to the flash emission unit 235. The flash emission unit 235 may perform a pre-flash before a main exposure and a main flash in the main exposure, and may be embedded in or detachable from the digital imaging apparatus 100.

The digital imaging apparatus 100 includes the CPU 240 that controls the overall operation of the digital imaging apparatus 100. The CPU 240 may output a predetermined control signal to the lens driving unit 112, the diaphragm driving unit 114, and the mirror driving unit 117 so that the lens driving unit 112, the diaphragm driving unit 114, and the mirror driving unit 117 are controlled according to exposure information, focus information, an external input signal, and the like. In the current embodiment, only one CPU 240 is included. However, the present invention is not limited thereto and may include a plurality of CPUs 240. In this case, each of the plurality of CPUs 240 may perform commands related to a signal system and to a manipulation system.

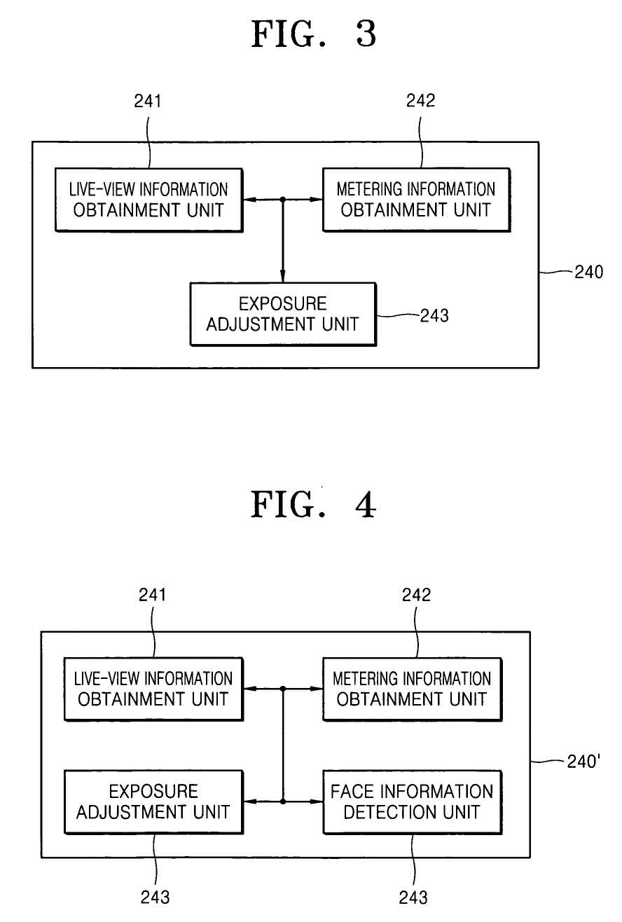

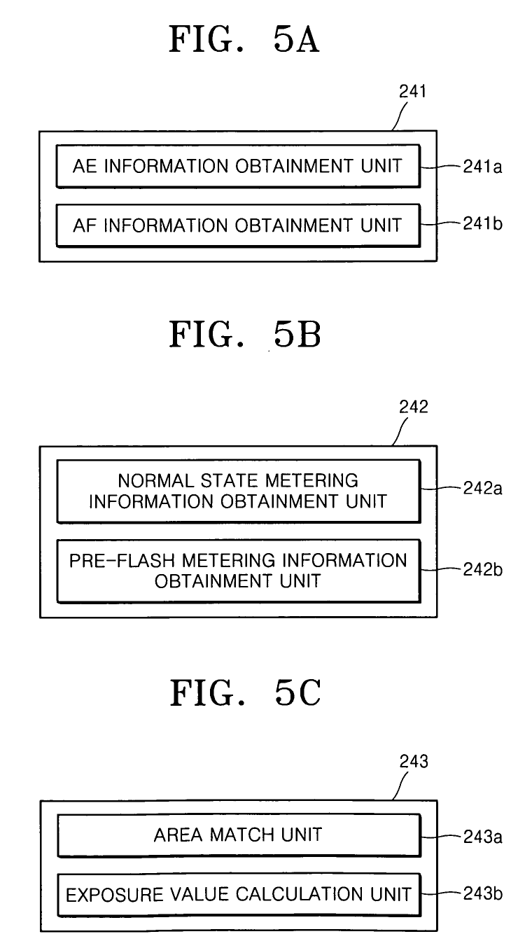

FIG. 3 is a block diagram illustrating a schematic structure of the CPU 240 according to an embodiment of the present invention. FIG. 4 is a block diagram illustrating a schematic structure of a CPU 240′ according to another embodiment of the present invention. FIGS. 5A though 5C are block diagrams illustrating a detailed structure of the CPU 240, according to an embodiment of the present invention.

Referring to FIG. 3, the CPU 240 includes a live-view information obtainment unit 241, a metering information obtainment unit 242, and an exposure adjustment unit 243, according to an embodiment of the present invention.

Referring to FIG. 4, the CPU 240′ includes the live-view information obtainment unit 241, the metering information obtainment unit 242, and the exposure adjustment unit 243 of the CPU 240, and a face information detection unit 244, according to another embodiment of the present invention.

Thus, the CPU 240′ has the same structure as the CPU 240 except for the face information detection unit 244 and related functions thereof. Hence, hereinafter, the digital imaging apparatus 100 according to the present an embodiment of the present invention may be described with reference to the CPU 240, except for an explanation related to the face detection function.

Referring to FIGS. 5A through 5C, the live-view information obtainment unit 241 includes an automatic exposure (AE) information obtainment unit 241a and an autofocus (AF) information obtainment unit 241b. The metering information obtainment unit 242 includes a normal state metering information obtainment unit 242a and a pre-flash metering information obtainment unit 242b. The exposure adjustment unit 243 includes an area match unit 243a and an exposure value calculation unit 243b.

The live-view information obtainment unit 241 stores and maintains a plurality of pieces of data which are related to an image of a target subject and which are obtained when the image is displayed in live-view via the display unit 175, with the shutter 121 of the digital imaging apparatus 100 opened.

In the current embodiment, the live-view information obtainment unit 241 may include the AE information obtainment unit 241a which meters an optical signal input to the imaging device 131 and meters brightness of the target subject so as to store information necessary for an AE evaluation, when an AE is performed with respect to the target subject in the live-view of the digital imaging apparatus 100.

After the first shutter release button S1 is pressed, the CPU 240 controls an analog front-end (not shown) and the imaging device 131 to be changed to an image capture mode and an electric shutter speed which are appropriate for an AF, provides a focus driving command to a focus lens, and evaluates image data received at a speed of 30 through 60 pieces per second, thereby operating the focus lens so that a highest point by a space frequency value can be a focus position. At this time, the live-view information obtainment unit 241 may include the AF information obtainment unit 241b which stores and keeps information such as an AF evaluation value about a main target subject, an AF position about the main target subject, or a distance which is related to the target subject and which is obtained by the AF.

Meanwhile, in the case in which the digital imaging apparatus 100 includes the CPU 240′ with the face detection function if the main target subject is human, the face information detection unit 244 detects information about the number of faces, positions of the faces, sizes of the faces, and the like, from an image input in a live-view state. Also, by using such information, the AF information obtainment unit 241b detects information about an AF evaluation value, an AF position, and a distance to the human, based on the face of the human that is the main target subject.

Meanwhile, in the case where the lens 111 of the digital imaging apparatus 100 is an exchangeable type lens, a main body and an exchangeable lens exchange the information by tranceiving a command via a serial communication.

When an imaging start signal is input, before the main exposure, the metering information obtainment unit 242 meters light of a target subject received via the lens 111, by using the lighter sensor 220.

The metering information obtainment unit 242 may include the normal state metering information obtainment unit 242a that meters brightness of the target subject by using the lighter sensor 220 so as to obtain metering data, when the imaging start signal is input by pressing the second shutter release button S2 and when the imaging unit 130 is under the same condition as the pre-flash, without emission of the pre-flash.

Also, the metering information obtainment unit 242 may include the pre-flash metering information obtainment unit 242b that meters brightness of a reflected light of the target subject in the pre-flash when the imaging unit 130 emits the pre-flash.

The exposure adjustment unit 243 calculates and adjusts a shutter speed, an F number, and flash light intensity, which are necessary for the main exposure, by using data obtained via the live-view information obtainment unit 241 and the metering information obtainment unit 242.

In the case where the live-view display screen may be divided into a plurality of areas, the area match unit 243a matches the divided areas of the lighter sensor 220 with the divided areas of the live-view display screen.

The exposure value calculation unit 243b calculates a main exposure condition by using the metering information for each divided area of the lighter sensor 220, which is obtained by the live-view information obtainment unit 241 and the area match unit 243a.

Meanwhile, in the case in which the digital imaging apparatus 100 includes the CPU 240′ with the face detection function, if the main target subject is human, image data displayed in the live-view display screen may be divided into a face area and a non-face area. At this time, the exposure value calculation unit 243b matches a divided screen, obtained by dividing the live-view display screen into the face area and the non-face area, with the divided areas of the lighter sensor 220.

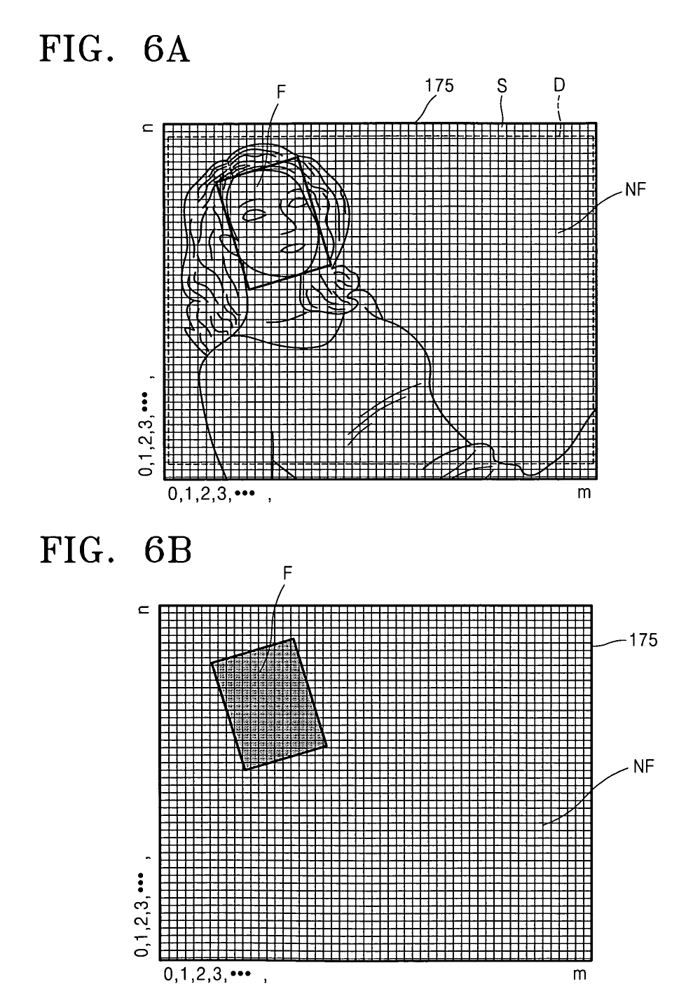

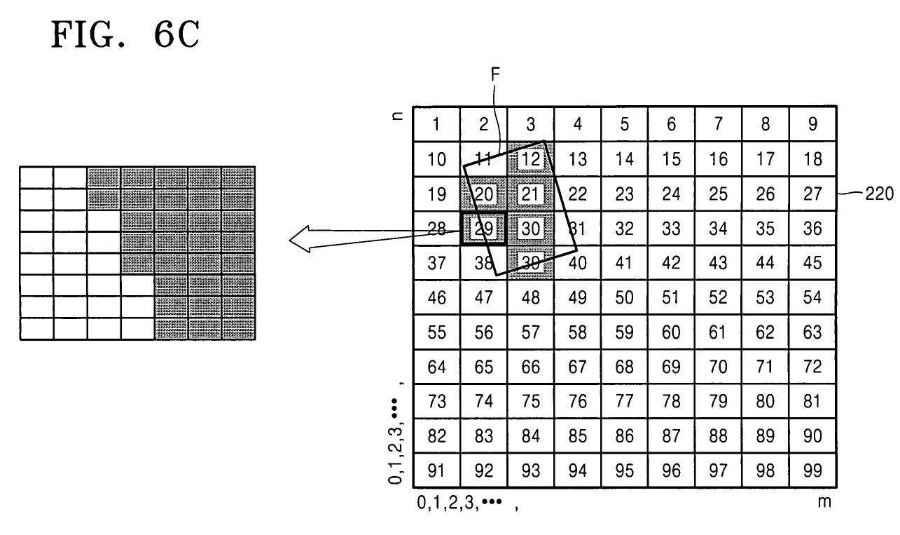

FIGS. 6A through 6C are drawings illustrating a process in which the area match unit 243a matches the divided areas of the screen in the live-view with the divided areas of the lighter sensor 220, according to an embodiment of the present invention.

FIGS. 6A through 6C are related to the case in which the digital imaging apparatus 100 includes the CPU 240′ with the face detection function and a main target subject is a human. However, the present invention is not limited thereto. That is, the spirit and scope of the present invention may be applied to digital imaging apparatuses having a function that divides an image of a target subject, displayed in a live-view state, into a plurality of predetermined areas and recognizes each divided area.

In FIG. 6A, a woman is displayed in a live-view mode via the display unit 175. An area S of the display unit 175 is an area not displaying an image. A screen of an area D being displayed may be divided into a face area F and a non-face area NF, according to the face detection function of the digital imaging apparatus 100.

FIG. 6B corresponds to a middle procedure for setting a position of the face area F with respect to the non-face area NF of the target subject in a live-view display screen.

The position of the face area F by a live-view may be determined according to positions of a plurality of image display cells forming the display unit 175. In the current embodiment, the display unit 175 includes a total of m×n (m, n=0, 1, 2, . . . ) image display cells. Here, the number of the image display cells may be equal to the number of pixels forming the display unit 175 but the present invention is not limited thereto. That is, one image display cell may comprise all of the pixels forming the display unit 175, and may correspond to pixels of the imaging device 131 such as a CCD or a CMOS according to a predetermined manner. Meanwhile, the number of the image display cells displayed in FIGS. 6A through 6C is only an example, and may vary.

FIG. 6C is a diagram illustrating an area of the lighter sensor 220, which corresponds to the face area F in the live-view display screen.

Referring to FIG. 6C, the area of the lighter sensor 220 is divided into a total of 9×11 sensor cells. Each of the sensor cells is formed of a plurality of sub-sensor cells. The number of the sensor cells and the number of the sub-sensor cells may vary.

The face area F in the live-view display screen corresponds to sensor cells 12, 20, 21, 29, 30, and 39 of the lighter sensor 220. These sensor cells are among sensor cells including at least a part of the face area F and in which greater than 50% of sub-sensor cells corresponding to the face area F are included. Here, this percentage value (%) may be differently set.

As described above, the area match unit 243a may divide the image of the target subject displayed in the live-view via the imaging device 131 into the face area and the non-face area, and may match each of the divided face and non-face areas with each sensor cell of the lighter sensor 220. Thus, the exposure value calculation unit 243b calculates a main exposure condition by using the metering information for each divided area of the lighter sensor 220, which is obtained by the live-view information obtainment unit 241 and the area match unit 243a. An example regarding the calculation of a main exposure value will be described later.

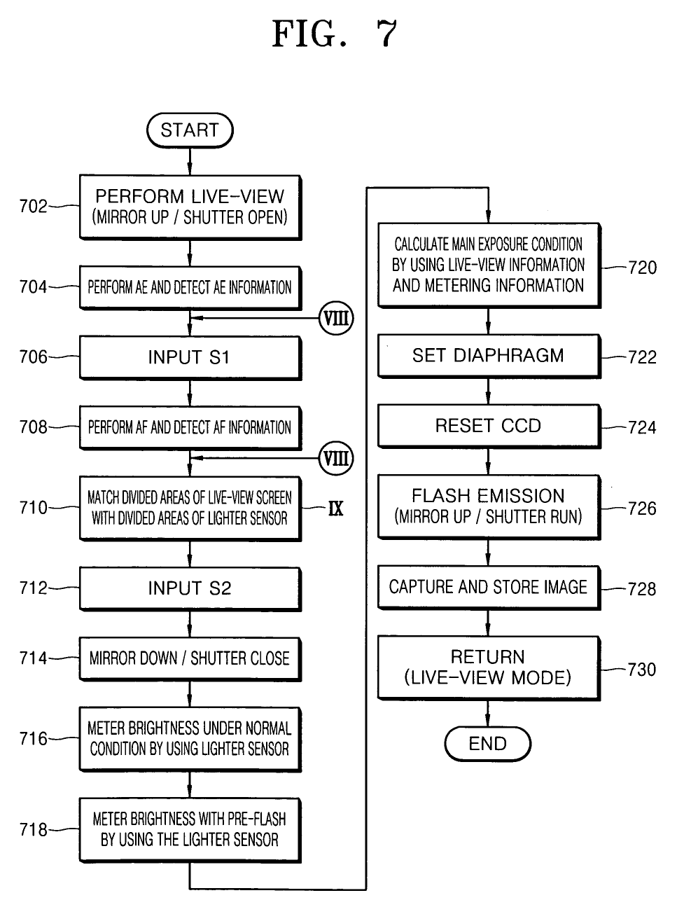

Hereinafter, a method of operating the digital imaging apparatus 100 will be described with reference to FIGS. 7 through 9.

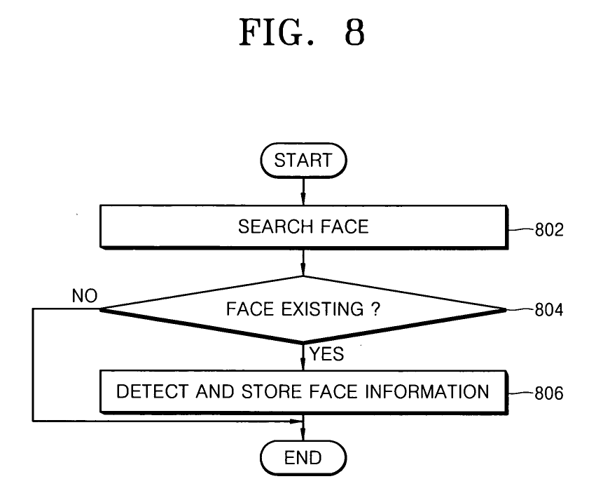

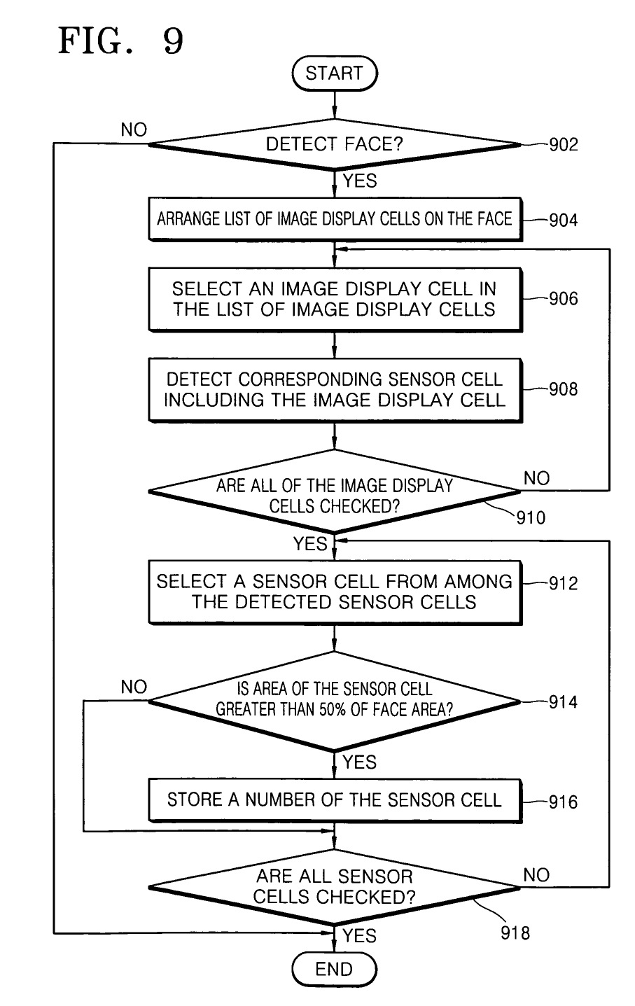

FIG. 7 is a flowchart of an operation of the digital imaging apparatus 100, according to an embodiment of the present invention. FIG. 8 is a flowchart of an additional operation of the digital imaging apparatus 100 with a face detection function, according to another embodiment of the present invention. FIG. 9 is a detailed flowchart of operation 710 in FIG. 7, according to an embodiment of the present invention.

Referring to FIGS. 7 through 9, a method of controlling a single capture sequence will now be described in the case where an AE and an AF via a live-view of the digital imaging apparatus 100 are performed.

First, when a power ON signal is input (not described in FIGS. 7 through 9) to the digital imaging apparatus 100, the digital imaging apparatus 100 is operated.

After that, when a user inputs a decision about a ready-to-capture state via the live-view, the reflex mirror 115 swings upward and the shutter 121 opens (operation 702). At this time, a capture setting in the live-view by the imaging device 131 is performed, and a live-view display screen is displayed in the display unit 175 so as to inform the user that an imaging operation is ready.

Then, the digital imaging apparatus 100 measures brightness of a target subject in a live-view capture of every frame and detects information necessary for a live-view AE evaluation, thereby storing and maintaining the information (operation 704).

Meanwhile, referring to FIG. 8, the digital imaging apparatus 100 with the face detection function may search for a face in the measurement of the brightness (operation 802). When the face is detected (operation 804), face information about the number of faces, positions of the faces, and sizes of the faces is detected and stored (operation 806).

Next, according to a user's decision about the imaging operation, when an S1 signal is input by pressing a first shutter release button, the digital imaging apparatus 100 starts an AF operation (operation 706). At this time, since the reflex mirror 115 is still up and the shutter 121 opens, the user may view a screen on which an image is displayed in the live-view via the display unit 175.

When the AF operation is performed, image data received at a speed of 30 through 60 pieces per second is evaluated to operate a focus lens so that a highest point by a space frequency value can be a focus position. At this time, the digital imaging apparatus 100 may obtain information such as an AF evaluation value about a main target subject, an AF position of the main target subject, or a distance which is related to the target subject and which is obtained by the AF operation (operation 708).

Although not shown in FIGS. 7 through 9, an AF lock and an AE lock are commonly performed in operation 708.

Meanwhile, as illustrated in FIG. 8, the digital imaging apparatus 100 with the face detection function searches for a face when the AF operation is performed (operation 802). When the face is detected (operation 804), face information about the number of faces, positions of the faces and sizes of the faces may be detected and stored (operation 806).

At this time, in the case where the live-view display screen may be divided into a plurality of areas and the lighter sensor 220 may meter a light of each divided area, the area match unit 243a matches each divided area of the live-view screen with the corresponding divided area of the lighter sensor 220 (operation 710).

Hereinafter, a procedure, in which operation 710 is performed in the digital imaging apparatus 100 with the face detection function, will now be described in detail with reference to FIG. 9.

First, when a face is detected in a live-view display screen (operation 902), the area match unit 243a arranges a list of image display cells on the face in the live-view display screen (operation 904).

Next, an image display cell in the list of image display cells is selected (operation 906), and a corresponding sensor cell, which is of the lighter sensor 220 and which includes the image display cell, is detected (operation 908). Operations 906 and 908 are repeated until all corresponding sensor cells of the lighter sensor 220 are detected with respect to all image display cells on the face (operation 910).

Next, a sensor cell from among the detected sensor cells of the lighter sensor 220 is selected (operation 912).

In the case where an area of the sensor cell corresponding to an image display cell on the face is determined to be greater than 50% (operation 914), a number of the sensor cell is separately stored (operation 916). At this time, as described with reference to FIGS. 6A through 6C, the determination in operation 914 may be performed based on whether the number of sub-sensor cells corresponding to the image display cell on the face is greater than 50%.

In this manner, operations 912 through 916 are repeatedly performed with respect to all sensor cells so that sensor cells corresponding to image display cells on a face area and sensor cells corresponding to image display cells on a non-face area are divided.

In the current embodiment, the main target subject is a human and a corresponding apparatus is the digital imaging apparatus 100 with the face detection function. However, a mechanism of the current embodiment is not limited to the division of the live-view display screen into the face area and the non-face area but may be applied to various methods of dividing the live-view display screen into a plurality of areas.

Referring back to FIG. 7, when a user presses a second shutter release button so as to input an S2 signal, the digital imaging apparatus 100 performs a main exposure sequence (operation 712).

When the S2 signal is input, the reflex mirror 115 swings downward and the shutter 121 is closed (operation 712).

Then, without emission of a pre-flash by the imaging unit 130, brightness of the target subject is metered by the lighter sensor 220 under a normal condition that is equal to the pre-flash (operation 716).

Next, the pre-flash is emitted by the imaging unit 130, and a reflected light from the target subject is metered (operation 718).

Based on metering information obtained in the normal condition and in the pre-flash, and based on AE and AF information detected in the live-view, the exposure adjustment unit 243 calculates a main exposure condition including a shutter speed, an F number, flash light intensity, and the like which are necessary for a main exposure (operation 720).

At this time, when the flash light intensity is calculated, a reflectance of the target subject may be metered by comparing a metering result under the normal condition to a metering result under the pre-flash. Also, in order to more precisely calculate the main exposure condition, pre-flash intensity of the flash emission unit 235 in the pre-flash or a gain of the lighter sensor 220 may be adjusted by referring to the target subject's brightness obtained in the AE of the live-view and by referring to the distance which is related to the target subject and which is obtained in the AF of the live-view. Also, a more precise main exposure condition may be obtained by changing the pre-flash intensity and the gain a plurality of times.

Hereinafter, the example regarding the calculation of the main exposure value by the exposure adjustment unit 243 will now be described with reference to FIGS. 10 through 12.

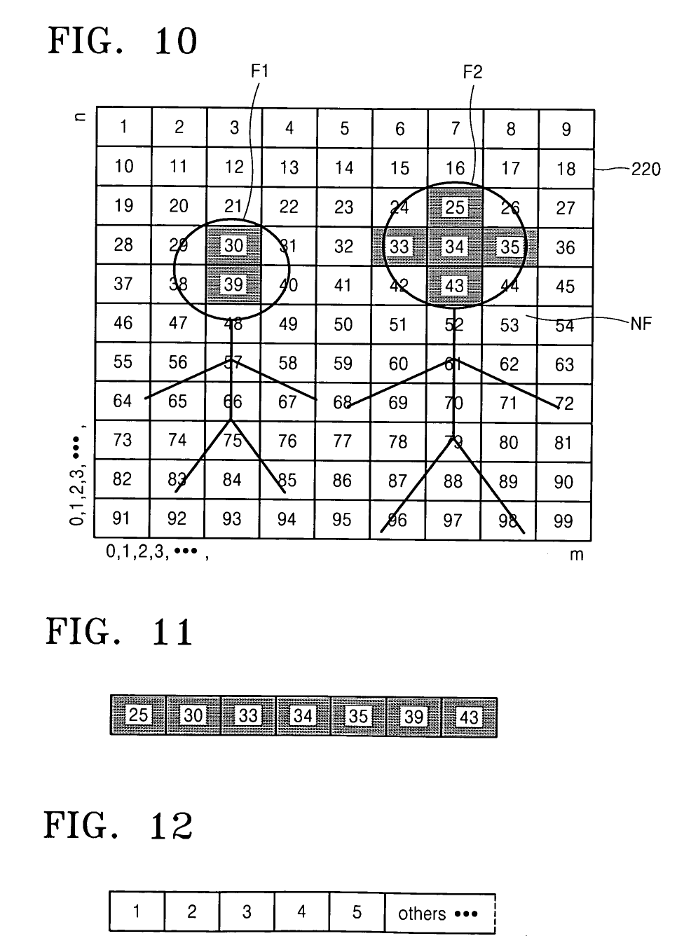

FIG. 10 is a drawing in which a sensor area of the lighter sensor 220 is divided into a face area and a non-face area by two persons. FIG. 11 is a group of sensor cells corresponding to the face area. FIG. 12 is a group of sensor cells corresponding to the non-face area.

Referring to FIG. 10, the sensor area of the lighter sensor 220 is divided into face areas F1 and F2 about the two persons and a non-face area NF excluding the face areas F1 and F2. Based on the explanation with reference to FIGS. 6A through 9, it may be possible to understand that the divided sensor area of FIG. 10 corresponds to a face area and a non-face area which are displayed in a live-view.

First, the lighter sensor 220 meters a light value of a normal state (LVN) without a pre-flash and a light value of a pre-flash (LVP) for each sensor cell illustrated in FIG. 10, and calculates a differential value (DLV) between the LVN and the LVP for each sensor cell.

Next, an average of the DLV for the sensor cells of the face areas F1 and F2 (DAVF) (see FIG. 11) and an average of the DLV for the sensor cells of the non-face area NF (DAVN) (see FIG. 12) are calculated.

When the DAVF and the DAVN are almost equal to each other, flash light intensity may be calculated to have a normal value.

Meanwhile, when the DAVF is higher than the DAVN, this means that faces of the two persons are close to a camera or the faces have a high reflectance. Thus, when the exposure adjustment unit 243 calculates the flash light intensity based on this, an over-exposure for the faces is prevented.

On the other hand, when the DAVF is lower than the DAVN, this means that the faces do not have a high reflectance. In this case, if the flash light intensity for the faces is calculated to have a relatively high value, an over-exposure for the non-face area NF may occur. Thus, an exposure result may be improved by reducing the flash light intensity and by adjusting an exposure time to be slightly longer.

Referring back to FIG. 7, after a completion notice is received by inputting a narrow diaphragm command to the diaphragm 113 based on the F number calculated in previous operation (operation 722), a charge of the imaging device 131 is reset (operation 724). After that, a main exposure is performed by an opening and closing operation of the shutter 121 (at this time, the reflex mirror 115 is up), with emission by the flash emission unit 235 (operation 726).

Meanwhile, in the current embodiment, the main exposure is performed with the emission by the flash emission unit 235 but the present invention is not limited thereto. For example, since better images may be captured without the emission by the flash emission unit 235, in this case, the flash light intensity may be controlled by including an option regarding non-emission of a flash, or a gain value of the imaging device 131 may be increased so that an imaging operation can be performed by exposing the imaging device 131, without the emission of the flash.

After the main exposure is completed, a captured image is stored (operation 730). If necessary, a ready-to-capture state in a live-view is started again by swinging upward the reflex mirror 115 and opening the shutter 121 (operation 730).

According to the digital imaging apparatus and the method of controlling the same according to various embodiments of the present invention, the AE and AF information obtained in the live-view can be used so as to adjust the flash light intensity when the imaging operation with the flash emission is performed. Thus, an exposure with merits of both conventional compact digital cameras and SLR digital cameras is possible so that high-quality images can be captured.

Also, when the imaging operation is performed, not only the imaging operation requiring the emission of the flash but also the imaging operation not requiring the emission of the flash can be correctly determined so that imaging errors can be reduced and the high-quality images can be captured.

An SLR digital camera has been described as an embodiment of the digital imaging apparatus according to the present invention. However, the present invention is not limited thereto. That is, it will be understood by one of ordinary skill in the art that the spirit and scope of the present invention for performing the exposure by using the information obtained in the live-view can be applied to digital image capturing apparatuses in which a live-view display is possible, with a shutter opened, and which has a lighter sensor.

The present invention can be applied to a computer readable recording medium having recorded thereon a program for executing the method of controlling the digital imaging apparatus. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

Also, the computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a digital imaging apparatus enabled to maintain a ready-to-capture state, with a shutter of the digital imaging apparatus opened, the method comprising:
(a) displaying an image of a target subject in a live-view, with the shutter opened;
(b) obtaining live-view information of the image;
(c) when an imaging start signal is input, before a main exposure, metering reflected light from the target subject by using a lighter sensor;
(d) obtaining metering information;
(e) determining a condition for the main exposure by using the live-view information and the metering information; and
(f) performing an imaging operation while performing the main exposure by using the determined condition for the main exposure.

2. The method of claim 1, wherein:
in (a), displaying the target subject on a display screen enabled to be divided into a plurality of areas; and
in (c), the lighter sensor is enabled to perform metering for each of a plurality of divided areas of the lighter sensor and which respectively correspond to the plurality of divided areas of the display screen.

3. The method of claim 2, wherein the live-view information comprises position information about a main target subject.

4. The method of claim 3, wherein the position information about the main target subject comprises a focus position obtained when an AF (autofocus) is performed.

5. The method of claim 4, wherein the live-view information further comprises information about a part of a human that is the main target subject.

6. The method of claim 5, wherein the information about the part of the human comprises face information of the human.

7. The method of claim 6, wherein the face information of the human comprises at least one of the number of faces, positions of the faces, and sizes of the faces.

8. The method of claim 2, wherein the live-view information comprises brightness information about the main target subject, when an AE (automatic exposure) is performed.

9. The method of claim 1, wherein (c) comprises metering reflected light in a normal state without a pre-flash and metering reflected light with the pre-flash.

10. The method of claim 9, wherein the live-view information affects the metering information.

11. The method of claim 1, wherein the main exposure in (f) is performed with emission of a flash.

12. The method of claim 1, wherein the main exposure in (f) is performed without the emission of a flash.

13. The method of claim 1, wherein:
in (a), displaying the target subject on a display screen enabled to be divided into the plurality of areas; and
in (c), the lighter sensor is enabled to perform metering for each of a plurality of divided areas of the lighter sensor which respectively correspond to the plurality of divided areas of the display screen; and
wherein the live-view information comprises:
information about a face that is the main target subject;
focus position information about the face when an AF is performed; and
brightness information about the face when an AE is performed.

14. A computer readable recording medium having recorded thereon a program for executing a method of controlling a digital imaging apparatus enabled to maintain a ready-to-capture state, with a shutter of the digital imaging apparatus opened, the method comprising:
(a) displaying an image of a target subject in a live-view, with the shutter opened;
(b) obtaining live-view information of the image;
(c) when an imaging start signal is input, before a main exposure, metering reflected light from the target subject by using a lighter sensor;
(d) obtaining metering information;
(e) determining a condition for the main exposure by using the live-view information and the metering information; and
(f) performing an imaging operation while performing the main exposure by using the determined condition for the main exposure.

15. A digital imaging apparatus having a shutter control device for maintaining a shutter-opened-state and a lighter sensor for metering a light having passed through one or more lenses, the digital imaging apparatus comprising:
a live-view information obtainment unit for obtaining and storing information when an image of a target subject is displayed in a live-view, with a shutter of the digital imaging apparatus opened;
a metering information obtainment unit for metering a reflected light from the target subject by using the lighter sensor and obtaining metering information; and
an exposure adjustment unit for adjusting an exposure condition for a main exposure by using the live-view information and metering information.

16. The digital imaging apparatus of claim 15, wherein the exposure adjustment unit comprises:
an area match unit for matching a live-view display screen enabled to be divided into a plurality of areas with a plurality of divided areas of the lighter sensor; and
an exposure value calculation unit for calculating the exposure condition for the main exposure by using metering information for each of the divided areas of the lighter sensor.

17. The digital imaging apparatus of claim 16, wherein the live-view information obtainment unit obtains position information about a main target subject in the live-view display screen.

18. The digital imaging apparatus of claim 17, wherein the position information about the main target subject, comprises a focus position obtained when an AF is performed for the main target subject in the live-view display screen.

19. The digital imaging apparatus of claim 18, wherein the live-view information obtainment unit further obtains information about a part of a human that is the main target subject in the live-view display screen.

20. The digital imaging apparatus of claim 19, further comprising a face information detection unit,
wherein the information about the part of the human comprises face information; and
the face information detection unit detects face information.

21. The digital imaging apparatus of claim 20, wherein the face information comprises at least one of the number of faces, positions of the faces, and sizes of the faces.

22. The digital imaging apparatus of claim 16, wherein the live-view information comprises brightness information about the main target subject, when an AE is performed.

23. The digital imaging apparatus of claim 15, wherein the shutter is a focal plane shutter.

24. The digital imaging apparatus of claim 15, wherein the digital imaging apparatus is a lens-exchangeable type.

25. The digital imaging apparatus of claim 15, wherein the digital imaging apparatus is an SLR (single-lens reflex) digital camera.
